(19) United States
(12) Patent Application Publication
(10) Pub. No.: US 2025/0314460 A1
(43) Pub. Date: Oct. 9, 2025

(54) Targeting apparatus and method for using information-theory enabled Target Indicators in GPS-denied environments

(71) Applicant: Peter Jonathan Cumpson, Sydney (AU)

(72) Inventor: Peter Jonathan Cumpson, Sydney (AU)

(21) Appl. No.: 19/015,632

(22) Filed: Jan. 10, 2025

(30) Foreign Application Priority Data
Apr. 9, 2024 (AU) AU2024900984
Apr. 13, 2024 (AU) AU2024901035
Jul. 29, 2024 (AU) AU2024902345
Aug. 31, 2024 (AU) AU2024902740
Nov. 5, 2024 (GB) GB2416317.2

(51) Int. Cl. F41G 7/22; G06T 7/73

(52) U.S. Cl. CPC F41G 7/2253; F41G 7/2293; G06T 7/73; G06T 2207/10032; G06T 2207/10048; G06T 2207/30204; G06T 2207/30252

(57) ABSTRACT

The invention provides a system for precise targeting in GPS-denied environments using a plurality of Computer-Readable Image Markers (CRIMs) and imaging devices. CRIMs, such as Apriltags, are deployed around a target area by an aerial vehicle. Each CRIM includes a unique code and an anchor that absorbs moisture to stabilize its position. High-altitude imaging devices capture the CRIMs' positions relative to the target, and this data is processed to create a map for autonomous navigation. An attack drone uses this map, identifying unmoved CRIMs to adjust its course and engage the target accurately, even in contested environments with electronic countermeasures. The method leverages robust image recognition, reducing computational load and enhancing reliability. The system offers a cost-effective solution for military and humanitarian applications where GPS is compromised.

### FIELD OF THE INVENTION

The present invention relates to systems and methods for autonomous navigation and targeting of munitions using Target Indicators (TIs) comprising Computer-Readable Image Markers (CRIMs) that will be of particular advantage in environments where GPS signals are denied. More specifically, it addresses targeting challenges faced by small drones, enhancing their operational reliability in contested environments. There are civilian applications in the drone-delivery of humanitarian aid in disaster mitigation.

### BACKGROUND OF THE INVENTION

In modern warfare, small unmanned aerial vehicles (UAVs), often referred to as Micro Air Vehicles (MAVs) or Mini Uncrewed Air Systems (MUAS), face significant challenges when navigating and targeting in GPS-denied environments due to electronic warfare and jamming. Traditional navigation methods, including visual navigation using natural landmarks, can be error-prone and resource-intensive, to quote a recent review: “one of the greatest hurdles to visual localization is that the computational requirements can easily exceed the resources available on a simple robot. To get around this problem, there are four different approaches: offload the computation to an external computer, utilize new technology, reduce the computational burden in software, and increase the processing power available to the robot”¹. Given the challenges of offloading computation when the electromagnetic (EM) spectrum is contested, and increasing the processing power available when there are weight and power restriction, we propose a new technology that reduces the computational burden in software via new technology.

There is a recognized problem in targeting specific battlefield targets with airborne drones (see for example newspaper articles²). The last mile, or few miles, to the battlefront is an important area. Electronic counter-measures can prevent effective communication with drones, or limit it to low data-rates, and certainly confuse GPS and similar navigational systems, so that any operator can find it difficult to direct a drone visually on the right target using (unreliable or absent) video transmissions from the drone. Often that means the drone operator must be within visual range of the target so as not to have to use a video link that could be compromised. This in turn puts the operator in more danger than they need be. Ideally the operator should be located in relative safety far behind the front line.

There is some discussion of this problem in the literature, but it is often (perhaps euphemistically) couched in terms of “docking” rather than targeting³. One approach to solve this problem is to use “artificial intelligence” or “machine learning” techniques to give the computer within the drone the capability to navigate using reference points from the natural environment (roads, rivers, trees, hedgerows etc). This is expensive—requiring much more powerful hardware and software than would otherwise be required to steer the drone alone. Trees can look similar. Buildings can look almost identical. In war even more visual interpretation errors can occur, as features in the landscape can change rapidly on the battlefield, and survey photos of the area can rapidly become out of date. Even things such as trees losing their leaves or long afternoon shadows can cause errors that take massive training sets to reduce.

Another approach is to employ inertial sensors and perhaps gyroscopes, often fabricated using Micro ElectroMechanical Systems (MEMS) techniques. Sometimes this is combined with optical measurements using “data fusion” methods⁴. However, the MEMS accelerometers and gyros that can be put onto a drone cheaply are not very accurate when their outputs are integrated over time to give position. The result is that the location accuracy of these methods is inadequate. A small drone with a small explosive payload needs to be directed with great precision, simply resulting from its small size. A grenade-sized explosive needs to be detonated within about a metre of the target. This is currently impossible over distances of 1 km or more using cheap inertial sensors, though data fusion with visual odometry may help. A larger payload, or a higher accuracy inertial sensor, would both be much more expensive to deploy.

The emphasis above on inexpensive methods is timely. It is a result of developments on battlefields since about 2020. Imagine, for a moment, that you are a soldier in a dugout somewhere in eastern Ukraine today. Stockpiles of expensive missiles are exhausted. In front of you are three small drones, each costing about US$1,000. Your task is eliminating an artillery piece (or a radar system, or a battalion HQ) tomorrow. You know that electronic warfare from your opponent means that, on average, only one of those three drones will get through. You are tempted to move closer to the target to overcome the jamming by having the target in visual range, even though that puts you in greater danger. The question is, what technology can we offer this soldier to make sure that the first drone reaches its target despite GPS-denial and jamming? It had better cost less than $2,000, because otherwise it is more cost-effective to send in three drones and accept the losses.

In the last 60 years, many brilliant pieces of technology have been developed to help autonomous navigation, from optical ring-laser gyros to radar terrain-following. The cheapest start at around US$50,000. Instead, we present a system that goes against conventional wisdom somewhat, but using modern digital methods allows GPS-denied accuracy of better than 0.5 metres over 20 km or more, and does it for much less than the cost of a single drone. This reliable method of “last-mile” targeting allows small drones or loitering munitions with existing resources to reach targets accurately without GPS, even in the last section of flight. It works with existing drone types and addresses the Target and Engage elements of the “Find, Fix, Track, Target, Engage, Assess” targeting cycle.

We do this using Computer Readable Image Markers. The use of Computer-Readable Image Markers (CRIMs), such as QR codes or Apriltags, has been explored in various applications, and indeed are sometimes used as landing markers for drones; however, their integration into autonomous targeting systems for MAVs presents unique challenges. The deployment and identification of these markers must be reliable and resilient to environmental factors that may affect their stability and visibility.

### SUMMARY OF THE INVENTION

The present invention introduces a system we call “FIDMARK,” designed to facilitate accurate and reliable last-mile targeting of munitions using Target Indicators (TIs). This system comprises:
1. A plurality of TIs that are dropped randomly around a target area.
2. A chemical anchor that absorbs moisture from the environment, increasing the weight of the TIs to ensure stability on the ground.
3. High-altitude imaging devices that capture the positions of the TIs relative to the target.
4. Processing units on the attacking device capable of identifying stable TIs based on their relative positions and poses, ensuring that only unchanged markers are used in target coordinates calculation.

In one embodiment the TIs are Computer Readable Image Markers or CRIMs. The invention allows for effective targeting even in complex electronic warfare scenarios, improving the accuracy of MAV operations while minimizing the risk to operators. Crucially an opponent cannot easily confuse the system, because the attacking drone knows which TIs have been deployed and can identify them (any additions will be ignored) and knows the relative position (and optionally orientation also) of the TIs so that even if some are moved, those can be ignored and guidance is based only on the TIs that have kept the same relative positions since those positions were captured from high altitude. The elimination of ambiguity is based on modern information-theoretic methods, such as using CRIMs with a large Hamming distance between them. It is crucial to this method that TIs have both position and identity associated with them, and that the identity is easy and reliably extracted from images captured by cheap digital imaging devices.

The drone (or other aircraft) that drops the TIs can do so at fairly-high altitude (and therefore relatively safely, and with only approximate inertial guidance) because the TIs only need to be dropped nearby, not exactly on, the target(s).

This sequence is shown in FIGS. 1 to 9. In FIG. 1, a drone (or other aircraft such as a manned fixed-wing or helicopter aircraft) (101), approaches the target, possibly from a high altitude carrying a plurality of TIs (102) held in place by a controlled release mechanism (105). The target (110) shown is an artillery piece, but may be any asset of the opponent such as a radar emplacement, battalion headquarters or others. FIG. 2 shows the release of TIs (210) from the aircraft after the release mechanism (205) is triggered, either on a remote radio command from an operator or when the aircraft has reached a pre-determined location as determined by its inertial guidance (for example). The TIs fall under gravity and scatter around the target. FIG. 3 shows the TIs (301) having fallen and lying on the ground in proximity to the target. FIG. 4 shows three optional devices for capturing the location of the fallen TIs after they reach the ground. A satellite (405), a manned aircraft (410) or a surveillance drone (415). Any combination, or one alone, of these may be used to provide image(s). The aircraft or drone may in fact be the same ones that dropped the TIs in some embodiments of this method. The satellite, aircraft or drone record images of the ground around the target, including the scattered TIs. These images are transmitted or otherwise returned to a command centre to be interpreted and the target position defined with respect to the fallen TIs. In one embodiment this is done by transmission of the images to a radio receiver (401) but it could also be by physically returning the digital images to a base as the aircraft returns, on a memory storage device. FIG. 5 shows an approaching attack drone or loitering munition (501). A camera in the said drone images the battlefield, and a computer in the drone identifies the TIs and their locations in 3D using projective geometry, typically by a matrix method. This is much faster, and more straightforward to implement, than artificial intelligence methods. In the time that has elapsed since the satellite and/or aircraft and/or surveillance drone imaged the same area previously, the coordinates of the target with respect to the TIs have been loaded into the attack drone. A human has decided where the target is in the image, and that position has been converted into the coordinates of that target (with respect to the CRIMs). An opponent can of course destroy TIs, or move them, or try to fool the system by adding new ones. None of these countermeasures will work, unless almost all of them are destroyed or moved. The attack drone is programmed only to use the positions of TIs that are on a stored list (each TI is individually identifiable with a serial number) so none can be added. It is programmed to use only the largest set of visible TIs whose relative positions have not changed. In FIG. 5 we show defaced or destroyed TIs (e.g 520) and TIs that have been moved (e.g. 530), but some have not been moved or destroyed (e.g. 510) and it is these alone that the drone uses to define the position of the target using the stored coordinates of the target relative to those unmoved TIs. The assumption is that those TIs whose relative position has not changed can be assumed to be in the same absolute position, and therefore target coordinates with respect to the unmoved TIs can be assumed to be still valid. To frustrate this process the opponent must destroy or displace almost all of the TIs (typically >75 out of perhaps 80 dropped) and even then, the attack drone would not be fooled as to its location—it would detect that all relative positions had changed and may be programmed to return to base. FIG. 6 shows the attack drone (601) heading to the target, which it has located based on imaging the remaining unmoved and undefaced TIs (610) by plotting a course (605). FIG. 7 shows the attack drone hitting the target successfully.

Even in an EM-contested area, low data rate communication (perhaps around 10 to 100 bits per second) may be possible even in the presence of jamming. This is not sufficient to allow visual images to be transmitted, but is enough to update the attacking drone with the new coordinates of an existing target, or the coordinates of a newly-identified target. An example is shown in FIG. 8, where the artillery piece (802) has been moved in response to the dropping of the CRIMs; the opposing army is attempting to avoid the impending drone attack. New and updated image(s) are recorded by satellite (or other high altitude surveillance device) 805 and transmitted as an uncontested high-bandwidth radio signal 810 back to a base 801 where a determination of the new position of the target artillery piece 802 is made, relative to the TI positions. This updated set of target coordinates is much more concise than any image, and easily transmitted to the attacking drone 830 over a low data-rate radio link 820 in a few hundred bytes. FIG. 9 shows the attacking drone hitting the target in the new target position.

In the next section we describe the matrix mathematics behind the projective geometry that enables the positioning of TIs to be deduced from images. We then develop a very approximate Bayesian model to show that this approach works reliably for the attacking drone even if roughly 95% of the TIs are moved or destroyed, under typical battlefield conditions.

### Projective Geometry Behind Identifying the 3D Position of a Drone Camera

The problem of identifying the 3D position (and orientation) of a drone camera with respect to two or more fixed CRIMs is an instance of the perspective-n-point (POP) problem in computer vision. This involves finding the position and orientation of a camera relative to known 3D points (here, the centres of the CRIMs, or each of their four corners).

The steps for determining the 3D position and orientation involve projective geometry and matrix operations:

### Camera Model: Pinhole Camera Approximation

A camera captures a 3D scene and projects it onto a 2D image plane. The relationship between a 3D point in the world (X, Y, Z) and its 2D image coordinates (u, v) is governed by the camera's intrinsic matrix K, which models the camera's internal parameters:

$$s ( \begin{matrix}u \\ v \\ 1\end{matrix} ) = K \begin{matrix}( R & t ) ( \begin{matrix}X \\ Y \\ Z \\ 1\end{matrix}\end{matrix} ) \qquad ( 1 )$$

where:
   s is a scaling factor.
   K is the intrinsic camera matrix.
   R is a 3×3 rotation matrix representing the camera's orientation.
   t is a 3×1 translation vector representing the camera's position.

### CRIM Detection: Image to 3D Correspondence

Each detected CRIM provides a 2D position on the image (u, v). Since the real-world coordinates of the CRIMs are fixed and known, the problem becomes one of finding the transformation between these 3D points and their 2D projections. For each CRIM, the center or comers provide corresponding points in both the image space and the world coordinate system.

### Pnp Algorithm (Solving for Pose)

Given two or more CRIMs, their known 3D positions (Xᵢ, Yᵢ, Zᵢ) (in world coordinates) and their detected 2D positions (uᵢ, vᵢ) (in image coordinates), you can solve for the camera's extrinsic parameters R (rotation) and t (translation). This process typically uses an algorithm like:
Direct Linear Transformation (DLT): A projective geometry-based method that uses a system of linear equations derived from multiple correspondences.
Iterative methods (e.g., Levenberg-Marquardt): Minimize the reprojection error, which is the difference between the observed 2D points and the projected 3D points under the current estimate of the camera pose.

### Solving the PnP Problem

For two or more CRIMs, we set up a system of equations relating their known 3D coordinates (X, Y, Z) and their detected 2D projections (u, v). These can be combined into a matrix equation of the form:

$$A \cdot X = 0 \qquad ( 2 )$$

where A is a matrix encoding the relationship between the image coordinates and the world coordinates, and X is the vector of unknowns related to the camera's position and orientation.

### Bundle Adjustment (Optional)

If there are more CRIMs detected, a bundle adjustment process can refine the camera pose by minimizing the reprojection error across all detected CRIMs in a non-linear optimization process.

### Homogeneous Coordinates and Perspective Transform

The process also involves transforming coordinates between 3D space and 2D image space using homogenous coordinates and projective transformations. These transformations are essential for relating the image points of CRIMs back to their known 3D positions in space.

### Practical Considerations:

Calibration: Accurate pose estimation relies on a well-calibrated camera, meaning that the intrinsic parameters (focal length, optical center, distortion) are known.

Noise and Accuracy: The solution's accuracy depends on factors like image noise, the number of CRIMs detected, and their distribution in the camera's field of view. The wider the spatial separation of the CRIMs, the more robust the pose estimation.

### Mathematical Process

### 1. Camera Model: Projection Equation

We model the relationship between a 3D point in the world coordinate system and its corresponding 2D projection on the image plane using the pinhole camera model. The equation is:

$$s ( \begin{matrix}u \\ v \\ 1\end{matrix} ) = K [ R \vert t ] ( \begin{matrix}X \\ Y \\ Z \\ 1\end{matrix} ) \qquad ( 3 )$$

### 2. CRIM Detection: Correspondences

For each detected CRIM, we know its:
3D world coordinates (Xᵢ, Yᵢ, Zᵢ) from the known, fixed positions of the tags in the environment.
2D image coordinates (uᵢ, vᵢ) from the camera's observation of the tag in the image.

### 3. Linearization of the Projection Equation

Rearrange the projection equation for each point:

$$\begin{matrix}{u}_{i} = \frac{{f}_{x} ( {r}_{11} {X}_{i} + {r}_{12} {Y}_{i} + {r}_{13} {Z}_{i} + {t}_{x} )}{{r}_{31} {X}_{i} + {r}_{32} {Y}_{i} + {r}_{33} {Z}_{i} + {t}_{z}} + {c}_{x} & ( 4 ) \\ {v}_{i} = \frac{{f}_{y} ( {r}_{21} {X}_{i} + {r}_{22} {Y}_{i} + {r}_{23} {Z}_{i} + {t}_{y} )}{{r}_{31} {X}_{i} + {r}_{32} {Y}_{i} + {r}_{33} {Z}_{i} + {t}_{z}} + {c}_{y} & ( 5 )\end{matrix}$$

where rᵢⱼ are elements of the rotation matrix R, and tₓ, t_{y}, t_{z} are components of the translation vector t.

### 4. Solving the Pose: Direct Linear Transformation (DLT)

We now solve for the unknown camera extrinsics (rotation R and translation t) using methods such as Direct Linear Transformation (DLT) or iterative methods.

DLT: We rearrange the equations into a linear system:

$$A \cdot x = 0 \qquad ( 6 )$$

where:
   A is a matrix that contains the known 3D world points and 2D image points.
   x is a vector of the unknowns related to the camera pose (rotation and translation).

Iterative Refinement: After an initial guess of R and r, nonlinear optimization methods refine the camera pose by minimizing the reprojection error:

$$Error = {\prod }_{i = 1}^{n} {‖ {u}_{i} - {\hat{u}}_{i} ‖}^{2} \qquad ( 7 )$$

where ûᵢ are the projected 2D points obtained from the estimated camera pose, and uᵢ are the actual detected image points.

### 5. Homogeneous Coordinates and Perspective Transform

The transformation from 3D world coordinates to 2D image coordinates involves converting the 3D world points into homogeneous coordinates. This allows for perspective projection to be modeled as a linear transformation:

$$( \begin{matrix}su \\ sv \\ s\end{matrix} ) = P ( \begin{matrix}X \\ Y \\ Z \\ 1\end{matrix} ) \qquad ( 8 )$$

where P=K[R|t] is the projection matrix.

### Bayesian Analysis of Object Movement

We aim to determine the probability that CRIMS have not been moved given that they appear to be in the same relative positions in two photographs (location followed by attack) taken at different times, and therefore represent a valid coordinate basis for targeting. We use Bayesian probability to update our beliefs based on the observations.

### Problem Statement

Let N be the total number of objects (typically 60 to 100) and M be the number of objects that appear in the same relative position in the attack run compared to the (satellite or surveillance drone) images. The prior probabilities are guessed as follows:
P(H₁)=0.3: The probability that the objects have not been moved by wind or people. So we assume a rather low probability that any one CRIM is in the same location it was initially. We guess there is a 70% chance that any one CRIM has moved.
P(H₂)=0.2: The probability that the objects have been moved but are still visible (e.g. by wind, animals, humans).
P(H₃)=0.5: The probability that the CRIM has been removed (e.g. destroyed, unobservable, covered by leaves etc).

### Likelihoods

The likelihoods of observing M objects in the same relative positions are:
P(E|H₁)=1: The probability of observing M objects in the same relative positions given that they have not been moved.
P(E|H₂)=0.2M: The probability of observing M objects in the same relative positions given that they have been moved but kept in the same relative positions (this is not going to be accidental-it's an attempt to fool the system).
P(E|H₃)=0: The probability of observing M objects in the same relative positions given that they have been removed.

### Marginal Probability

The total probability of observing M objects in the same relative positions is:

$$P ( E ) = P ( E \vert {H}_{1} ) \cdot P ( {H}_{1} ) + P ( E \vert {H}_{2} ) \cdot P ( {H}_{2} ) + P ( E \vert {H}_{3} ) \cdot P ( {H}_{3} )$$

$$P ( E ) = ( 1 \cdot 0.3 ) + ( {0.2}^{M} \cdot 0.2 ) + ( 0 \cdot 0.5 ) = 0.3 + 0.2 \cdot {0.2}^{M}$$

### Posterior Probability

Using Bayes' theorem, the posterior probability that the objects have not been moved given the evidence E is:

$$P ( {H}_{1} \vert E ) = \frac{P ( E \vert {H}_{1} ) \cdot P ( {H}_{1} )}{P ( E )} = \frac{1 \cdot 0.3}{0.3 + 0.2 \cdot {0.2}^{M}}$$

### Results

TABLE 1
Posterior Probability P(H₁|E) for different values of M

| M | P(H₁\|E) |
|---|---|
| 1 | 0.8824 |
| 2 | 0.9740 |
| 3 | 0.9947 |
| 4 | 0.9989 |
| 5 | 0.9998 |
| 6 | 1.0000 |
| 7 | 1.0000 |
| 8 | 1.0000 |
| 9 | 1.0000 |
| 10 | 1.0000 |

These results are summarised in FIGS. 13 and 14. FIG. 13 shows the probability of a valid coordinate system according to the number of surviving (unmoved, undestroyed) CRIM TIs. Clearly, the survival of three CRIMs is sufficient in 99.5% of cases to provide an accurate coordinate system for targeting, and 6 or more provided near certainty. Therefore, an opponent must destroy all but a few of 80 TIs dropped to frustrate accurate targeting.

Conclusions from these Calculations

As the number of CRIMs observed in the same relative positions increases, the probability of the coordinate system being unchanged (if the CRIMs whose relative positions define that coordinate system) increases. At around three or more CRIMs observed to be in unchanged positions the probability of the coordinate system being unchanged (i.e. accurately defining the target location) is effectively unity, representing near certainty. So out of perhaps 80 TIs distributed, each having a unique CRIM, provided at least around three of them survive unmoved, the attack drone can use those three to find its target accurately.

Note that, provided there is a low data-rate but reliable connection between drone and drone controller, the coordinates of the target with respect to the TIs can be updated during flight, indeed right up to the point at which that connection is lost. It takes only a few hundred bytes to communicate the updated target coordinates with respect to undisturbed CRIMs, which is much more difficult to disrupt by Electronic Warfare (EW) and/or jamming than disrupting an entire first-person-view (FPV) video link. FIG. 8 shows the attack drone memory being updated in this way. The target (802) has been moved by the opponent after the TIs were dropped. Nevertheless, the new coordinates of the target are passed to the attack drone (830) via radio signals 810 and 820, (in this case these coordinates originated from an updated image from a satellite (805) for example) via radio network 801. As illustrated in FIG. 9, that allows the attack drone to hit the target accurately at its new position.

Note that this method allows multiple drones to attack a target or target simultaneously and autonomously, so that the advantages of “swarming” can be applied even when there are insufficient drone operators to use first-person-view (FPV) drones to achieve it. Swarming is a powerful capability; to use a quote from the press, “It's entirely plausible, and we're embarking on it already, of letting artificial intelligence control the drones, and then you could have thousands of drones with just one person looking after them. And if enough are used, they'll overpower any system.”⁵. In the case of FIDMARK, artificial intelligence is not needed because TIs can be identified and located in images using traditional fast and robust algorithms. But the “overpowering” advantage is still there.

### Making TIs Immobile and Resistant to the Elements

It is desirable that TIs are low in mass when distributed, because a plurality of them must be dropped from a drone or other aircraft. Yet, if they are low in mass, it is likely that they will be blown-around easily in the wind and not maintain fixed marker positions. Clearly if we dropped TIs attached to heavy weights, they would be less likely to be disturbed by the environment (especially wind). Waterproofing is relatively easy, for example by making the TIs from a water-resistant polymer material or putting the TI inside a water-resistant transparent bag. More difficult is adding weight to the TIs to prevent them being blown away by the wind. To solve this, the TI can be firmly attached to a container that contains water absorbent or even deliquescent chemicals, that will absorb liquid water when it reaches the ground, or even moisture from the air. Examples of the chemicals that may be usefully incorporated to do this include the following, or a combination or mixture of the following;
1. Sodium (or potassium) polyacrylate, which absorbs roughly 30 times its own weight of water. So dropping TIs attached to containers of around 35 g of sodium polyacrylate, if the assembly lands in a wet environment, will increase in weight to around 1 kg and be immobile even in strong winds.
2. Calcium chloride dihydrate granules. These hold up to about 3 times their weight of water but can extract such water from moisture in the air. So, about 250 g of calcium chloride dihydrate, in a container firmly attached to the TI, will over time absorb enough moisture from the air to give the assembly a mass of 1 kg and make it immobile even in strong winds.
3. Lithium Chloride is deliquescent and absorbs water from the air down to around a relative humidity of only 12%.

This approach has the advantage that the initial weight of the TI assemblies is reduced, so that a smaller plane or drone can drop them but relies on water (or water vapour) being present on the battlefield to increase their mass and make them less mobile. The above chemicals are extremely cheap and made in huge quantities. Sodium polyacrylate is the absorbing material in child's nappies, and calcium chloride dihydrate is used in cheap chemical dehumidifiers. Other chemicals that may be used include NaOH and KOH, but these are corrosive, whereas the three above are safe by comparison-any civilian finding such things is unlikely to receive any harm from the chemicals involved. Silica gel is a possibility, but absorbs less water per unit mass than sodium polyacrylate, for example.

In some embodiments these chemicals may be contained within a “sock” made of material that air and water can penetrate easily (similar to those sold to mop-up water spills⁶ or act as tubular bandages for treating injuries) but which the hydrated chemicals cannot easily escape from. This may, for example, be attached to the circumference of a circular disc or square or rectangular CRIM to form a TI. Tubular cotton or rayon bandages are available cheaply that, when the above chemicals are added to be contained in the tube, can be glued or otherwise firmly attached to the CRIM.

We have performed several tests to reduce this to practice. Firstly, by leaving a commercial nappy outdoors on mud, followed by assemblies that have two (identical) Apriltag CRIMs, one on each side, so that which way up the assembly falls does not matter-sandwiching a layer designed to increase the mass of the assembly by taking up water, either as liquid or moisture vapour in the atmosphere. The first assembly had pieces of nappy cut-up in a plastic bag containing many holes. This was then thrown onto the ground in a muddy area after a day of light rain, to simulate battlefield conditions. Note that these assemblies are probably about two to five times smaller in linear dimensions than would be the real devices dropped on a battlefield, but the principles are the same. Next, a similar assembly was constructed but with CaCl₂) granules taken from a cheap domestic disposable chemical dehumidifier. These both worked well, gained mass over a few hours (more rapidly in the rain) and stayed visible on the ground, immobile, for many weeks even in windy condition.

### Practical Types of Target Indicator: Computer Readable Image Markers (CRIMs)

Human-made fiducial markers (such as CRIMs using Apriltags) are much easier to spot reliably in images with simple software, compared to adventitious features in the landscape (trees, buildings, roads etc). Examples may include QR codes and AprilTags. AprilTags are 2D barcodes or simplified QR codes that consist of squares in a unique pattern that can be detected by a camera. Both are widely used. Apriltags are designed for accurate determination of position and pose, with at least 4 different implementations of publicly-available software to identify and locate them in images. Apriltags are sometimes used as landing markers for small drones⁷.

An earlier filing (PCT/AU2023/050358) described how computer-readable fiducial markers (CRIMs), such as Apriltags or QR codes, can be used⁸ to navigate specimens in chemical analysis. These can be recognized automatically by software and the registration of the specimen improved.

In the case of some CRIMs, such as Apriltags, a range of software^{9,10,11} is available to identify them within a given recorded image. These can be very fast, so that waiting for the result is not a problem, even if many images must be searched automatically by a not very powerful computer. Other computer-readable fiducial markers¹² can be used in our invention. Examples are shown in FIGS. 10 and 11

There are often different “families” of CRIMs within a given type. For example, in the case of Apriltags there are families such as “16H5” and “36H11”. Each family has a different number of pixels in vertical and horizontal directions. The first number (for example the 16 in 16H5) is the number of data bits (changeable blocks) in the CRIM design; the second number (5 in 16H5) is the Hamming distance, the minimum number of bits that must be changed in the CRIM code to reach another CRIM code. With a larger first number, you can have more distinguishable tags in the same family; a larger second number means that there is more tolerance to incorrect bits.

In practice, incorrect binary digits aren't as much a problem as the prospect that some other non-AprilTags feature gets recognized as a false positive, an apparent AprilTag where there isn't one. Perhaps a speck of dust on a lens or some other random feature can be misinterpreted as an Apriltag.

### Table 2 Shows the Number of Bits Across (Width) and Number of Available Tags for Each Of Several Apriltag Families.

TABLE 2
Comparison of the properties of some Apriltag families.

| | Total | Width of | Fill | Number |
|---|---|---|---|---|
| Family Name | Width | Square | Factor | Of Tags |
| 16H5 | 8 | 6 | 0.75 | 30 |
| 21H7 Circle | 9 | 5 | 0.55 | 38 |
| 25H9 | 9 | 7 | 0.78 | 35 |
| 36H11 | 10 | 8 | 0.8 | 587 |
| 41H12 Standard | 9 | 5 | 0.56 | 2115 |
| 48H12 Custom (Hole) | 10 | 6 | 0.6 | 42211 |
| 49H12 Circle | 11 | 5 | 0.45 | 65535 |
| 52H13 Standard | 10 | 6 | 0.6 | 48714 |

Even with a hamming distance of 5 the 16H5 family can lead to quite frequent errors, just through random features appearing in a typical image.

Therefore, in embodiments using Apriltags an AprilTag family for which the chance of mistakes is vanishingly small is a better choice-perhaps 36H11 or 49H12 for example. Then we print a large number of these, each having different code numbers—on both sides—on stiff paper or plastic sheets. An example of one sheet of this kind is shown schematically in FIG. 12.

Each sheet may have an “anchor” attached—a device designed to stop the sheet moving too much when on the ground. This could be a weight with some spikes attached, for example, able to anchor itself in earth. We propose increasing the weight by absorbing water from the environment without imposing extra weight requirements on the drone or plane delivering these CRIMs to the battlefield using the chemicals described above. Both sides of the sheet should have the same code number, so that it does not matter which way up they land.

There is no need for these codes to be human readable-indeed there may be an advantage in printing them using (for example) infra-red absorbing inks, so that the sheet just looks white to the human eye but the CRIM is clearly visible to a camera in the near infra-red. They could even be camouflaged in the optical wavelength range so that it would not be trivial for a human to spot them. In a city the camouflage could be as an A4 file folder or something similar, as must be released when any office is bombed.

Large numbers (perhaps 60 to 100) of these are dropped from an aircraft or drone onto the enemy side of the battlefield. Even in GPS-denied conditions, no great accuracy in dropping is needed, so the drone or aircraft that drops them could use relatively cheap inertial navigation accurate to a few hundred metres. As discussed above, they fall at random, and are difficult for the enemy to collect or destroy without putting themselves in danger of being fired upon. The battlefield is then imaged, either from a high-altitude manned aircraft, reconnaissance drone or orbiting satellite, and the locations of the CRIMs are identified with respect to the priority target(s). A digital map is generated marking the locations of the CRIMs and their code numbers, as well as the high-value priority target(s). The coordinates of the target(s) are then known with respect to those of the CRIMs. Importantly this map generation can be done from a high altitude and does not require continuous direction from the ground—it could be done autonomously by reconnaissance drone for example. Attack drone(s) are then programmed with the coordinates of the targets with respect to the positions, and even the “pose” of nearby uniquely-identifiable CRIMS. CRIMs are easily identified by the drone camera with no significant chance of false-positives because of the large hamming distance of the codes. Some codes may go missing between being mapped on the battlefield and the drone arriving, but enough to uniquely-locate the target will likely remain, and if not, the drone will “know it is lost” and perhaps be programmed to detonate safely in case it has wandered into civilian areas.

Countermeasures are difficult because it's difficult to remove the CRIM sheets. The enemy may try adding sheets to confuse things, but if the numbers on those added sheets are not on the list of valid sheets held by the attack drone, the drone can be programmed to ignore them. For example, if there are 65535 different possible CRIM numbers (as there are for the 49H12 Apriltag family) then perhaps 3000 of these (i.e. less than 5%) are chosen at random and a list kept of which ones are chosen. If n=456 is on the list but not n=457 (for example) then the attacking drone knows that any Apriltag with n=457 is a fake because its not on the list.

Similarly, if a set of CRIMs are in relative locations that differ from those in the map, the drone software may conclude that either the enemy has moved some, or they have been blown around, and again, safe detonation may be the best option.

There are aspects of this solution that are reminiscent of “blockchain” methods. If one individual CRIM is moved or destroyed the effect is minimal—it's the relative arrangement of CRIMs that is important. Some may disappear, moved or covered, but overall there is enough redundancy (if many CRIMs are distributed) to allow the drone to find its target exactly. Just as in the case of a blockchain, all copies of the CRIM signposts must be changed in order to confuse the attacking drone, and this is impractical. Some CRIMs will land out of sight of anyone on the ground (on a rooftop for example) and won't even be seen let alone destroyed or moved.

It is anticipated that the whole process could be quite rapid, perhaps all within an hour and certainly a day. Dropping the TIs, mapping them, downloading information to the drones and the drones arriving could all be done too rapidly for the enemy to do very much to stop it.

### Operation at Night

Instead of printing the CRIM in black-and-white, during the night it may be good to take advantage of the ability to print CRIMs using fluorescent ink. In the dark, the attacking drone may be programmed to emit periodic, intense, UV light pulses, for example. Bright UV light emitting diodes are now quite capable of this, at least for short pulses. These may be chosen to cause ink in the CRIM to fluoresce, either in the optical range or even in the infrared. Even if the fluorescent intensity is small, subtracting an image without UV illumination from one with UV illumination would reveal TIs in the field of view with good signal-to-noise. The drone will take more than one image, before and/or after the image(s) taken during UV illumination. Subtracting them will show the CRIMs more clearly. If the fluorescence occurs in the infrared then a human observer would be oblivious to the whole process, unless they had special equipment. Again, this could be combined with visible-range camouflage for the CRIMs.

In this case it may be wise for the drone to be programmed to take random evasive maneuvers immediately after each UV pulse-otherwise countermeasures could involve pin-pointing the source of the pulse as a target.

### Metamerism and Similar Principles

As an alternative way of avoiding detection of the TIs, instead of printing the CRIM in black-and-white, one can use the concept of metamerism (see for example US patent US20050166781A1) to create a CRIM fiducial marker like an Apriltag that appears featureless or inconspicuous to the human eye in sunlight but is clearly visible to a camera equipped with appropriate filters. Here's how this works:

### 1. Selective Reflectance and Emission

Metamerism embodiment: The CRIM fiducial marker could be designed with materials that reflect or emit light differently at specific wavelengths outside the visible spectrum (e.g., in the near-infrared or ultraviolet ranges). These differences would not be detectable by the human eye, which primarily perceives light in the 400-700 nm range. However, a camera equipped with filters tuned to these specific wavelengths could easily detect the marker.
Implementation: The marker could be printed or coated with materials that are specifically designed to have low contrast in the visible spectrum but high contrast in the near-infrared (NIR) or ultraviolet (UV) spectrum. For example, certain dyes or pigments that are nearly identical in the visible spectrum might reflect light very differently in the NIR range, making the marker stand out when viewed through an NIR-sensitive camera.

### 2. Multispectral or Hyperspectral Fiducials

Beyond Visible Light: CRIMs could be designed with patterns that are optimized for detection in specific non-visible wavelengths. For example, certain inks or coatings can be invisible or very faint in the visible spectrum but highly reflective in the NIR or UV, making them ideal for detection by drones or satellites with the right sensors.
Possible embodiment: A drone equipped with a multispectral camera that can detect NIR light could easily identify the fiducial marker, while it remains inconspicuous to a person on the ground.

### 3. Polarisation and Structured Light

Polarisation: Some materials reflect light with different polarizations depending on the angle of incidence or the surface structure. A fiducial marker could be made using materials that appear featureless in normal sunlight but reveal patterns when viewed with a polarised light filter. Such surfaces can be printed (e.g. printed test cards for polarising sunglasses are widely used in high-street opticians to demonstrate polarisation).
Structured Light: Using structured light patterns that are only visible under specific lighting conditions or through specific filters could also serve the purpose. For example, applying a pattern using UV-reactive paint could make the marker visible under UV light, but invisible under normal sunlight. This is a more general case of the fluorescence method described above.

### Practical Considerations

Environmental Factors: The effectiveness of this approach would depend on environmental conditions, such as the amount of ambient light in the specific wavelength range used for detection. The drone or satellite would need sensors that are sensitive enough to detect the marker against the background noise.
Material Selection: Selecting the right materials that exhibit the desired spectral properties while being durable and resistant to environmental degradation is crucial.

### EXAMPLE IMPLEMENTATION

NIR-Sensitive Apriltag: One could create an CRIM having an Apriltag that is printed with inks that are nearly indistinguishable from the background in visible light but have a high contrast in the NIR spectrum. The tag would appear almost featureless to a person looking at it, but a drone equipped with an NIR camera would easily detect and decode the tag.

By leveraging metamerism and multispectral design, CRIM fiducial markers serve as a stealthy reference point for drones or satellites while remaining hidden from human observers on the ground. In addition, as described in US20050166781A1, metameric printed items can be made difficult to photocopy by the existence of that metamerism (inks respond differently to the photocopier light compared to sunlight) just in case the enemy tries to locally copy CRIMs to confuse the attack on them.

This then leads to the possibility in some embodiments of this invention to include multispectral or hyperspectral camouflage.

### 1. Multispectral Camouflage

Multispectral camouflage involves designing materials that can obscure an object across multiple parts of the electromagnetic spectrum, such as visible, infrared (IR), and ultraviolet (UV). The goal is to make the object difficult to detect with a variety of sensors, not just the human eye.
Reference: “Multispectral Camouflage Coatings for Ground Vehicles” by U.S. Army Research, Development and Engineering Command (RDECOM). This document discusses efforts to create coatings that provide camouflage across multiple wavelengths.

### 2. Hyperspectral Camouflage

Hyperspectral camouflage takes this concept further by attempting to blend objects into their surroundings across a very fine spectrum of wavelengths, which is crucial for defeating hyperspectral imaging systems that can detect subtle differences in spectral reflectance.
Reference: “Hyperspectral and Multispectral Camouflage Techniques” in the book Hyperspectral Remote Sensing of Vegetation by Prasad S. Thenkabail et al., which discusses various approaches to camouflage and detection across spectral bands.

### 3. Spectral Signature Management

This term refers to the broader practice of managing the spectral reflectance properties of military assets to reduce their detectability across different sensor modalities.
Reference: The DARPA (Defense Advanced Research Projects Agency) “Adaptive Camouflage Systems” program has explored adaptive camouflage techniques, including those based on managing spectral signatures across multiple bands.

### 4. Chlorophyll-Mimicking Camouflage

Specific efforts have been made to mimic the spectral properties of chlorophyll and other natural materials to make military assets less detectable. The focus is on designing materials that replicate the reflectance of chlorophyll in the visible and near-infrared spectra.
Reference: Articles and research papers from the Journal of Defense Modeling and Simulation, which discuss camouflage techniques that mimic natural vegetation, including the spectral properties of chlorophyll.

Any combination of these methods can be useful in making the areas that define the Apriltag (the black and white areas in the figures above) clear to a “friendly” drone or satellite, and difficult to find by an enemy drone, satellite or personnel. Indeed, ideally the camouflage could mimic the surroundings, e.g. foliage.

If the CRIMs are no longer useful, or the battlefront has moved, another batch could be dropped after a day or two. In any case, CRIMs that are more robust with respect to occlusion (e.g. by leaf-litter) could be used, eg the RUNE-Tag¹³ method or ArUco tags¹⁴ which may prolong their useful life as targeting aids.

The survival lifetime of these CRIMs probably depends very sensitively on the local environment. Other anchoring methods may be used, or indeed a combination used together. For example, cement powder may be used as filler of the CRIM “sandwich”, so that on the ground it will gradually flow out and then solidify in the presence of moisture, fixing the CRIMs to soil or other surface. Alternatively, a light-curable adhesive may be allowed to flow out from the sandwich, so that sunlight effectively glues the CRIM to the surface on which it has fallen. A combination of some or all of these immobilization aids would be very effective. As regards accidental coverage by e.g. leaf litter, some types of fiducial marker can be chosen to be very robust to this¹⁵

Overview of the System: The FIDMARK system employs CRIMs, which can be QR codes, Apriltags, or other similar fiducial markers. These markers are designed to be lightweight and made of durable materials, ensuring they can withstand various environmental conditions while remaining identifiable by the onboard imaging systems of the drones.

CRIM Deployment and Stabilization: The CRIMs are distributed in a defined area by being dropped from an aircraft or drone. To enhance their stability and prevent displacement due to wind, each CRIM includes a chemical anchor that absorbs moisture from the environment. For example, sodium polyacrylate can absorb water, significantly increasing the CRIM's weight and preventing it from being blown away.

High-Altitude Imaging and Target Identification: Once the CRIMs are deployed, a high-altitude imaging device, such as a reconnaissance drone or satellite, captures images of the area. The processing unit analyzes these images to identify the locations of the CRIMs and their relative positions to the target(s). The system generates a digital map that marks these locations and allows for accurate targeting.

Stable Position Criteria: To enhance targeting reliability, the processing unit is programmed to ignore any CRIMs that exhibit a change in relative position or pose compared to their initial configuration as recorded in the imaging data. This feature ensures that only CRIMs maintaining unchanged relative positions in 3D space are used for autonomous navigation and targeting, thereby increasing the likelihood of accurate targeting.

Operational Advantages: The FIDMARK system is designed to operate autonomously, requiring minimal human intervention once CRIMs are deployed. The use of inexpensive and widely available materials and technologies ensures that the system can be deployed at scale, making it a cost-effective solution for military operations. As a recent Chinese military report¹⁶ on drone countermeasure lessons from Ukraine put it “By interfering with the navigation system and data links, the loitering munition will become a headless fly,” and “compared with high-energy lasers, microwave weapons have longer range, are less affected by weather, and have better firepower control, making them more suitable for dealing with drone swarm attacks”. We conclude that the solution to both these countermeasures is to put the drone flight controller and navigation system in a screened metal box, requiring only a camera behind a conductive indium-tin oxide window. We thereby protect the drone against any electronic warfare from DC to beyond microwave range. The navigation method we propose will then guide this system to its target, potentially as one member of a swarm of similar munitions that would be extremely difficult to stop.

In summary, the invention includes a four-step procedure for navigating “kamikaze” drones or small loitering munitions in GPS-denied conditions:
1. Signpost distribution: Before an attack, around 80 CRIMs (in one embodiment about A2 size) are dropped from an aircraft or drone near the target area. These randomly falling markers are difficult for the enemy to collect or destroy without risking exposure to fire. Only 3 out of 80 need to survive for precise navigation, and they can be camouflaged to avoid detection.
2. Signpost location: The area is then imaged using high-altitude aircraft, reconnaissance drone, or satellite to identify the CRIMs' locations, in one embodiment these are relative to the target(s) in a common NATO MGRS system. This is automatic.
3. Target selection: An automated digital map is generated from these images, marking the CRIMs and their codes, as well as the target(s). Detection of CRIMs in images is automated using existing software. A human selects the target location.
4. Navigation and strike: Attack drone(s) are programmed with the target coordinates relative to the CRIMs. The CRIMs are identified in milliseconds by the drone camera with no false positives, using an inexpensive digital image sensor and a simple processor running software that has been proven in other fields for the last ten years.

The drone that distributes the CRIM signposts only needs inertial navigation, accurate within hundreds of meters. The exact location of the signposts is determined by satellite or “HALE/MALE” drone such as the Hermes 900, Airbus Zephyr, MQ-9 Reaper or others used by NATO, needing only relative positional accuracy. The target selection is then made by a human operator using these images.

In the past, this system would have been unsuitable for large-scale conflicts, but the Ukraine war has changed economic constraints. Currently, Ukraine plans to deploy a million drones costing about $1,000 each, with many failing due to jamming and GPS denial. Our approach counters this, though in conventional terms it would be deprecated because it loses the element of surprise. The new situation means losing the element of surprise is less of a disadvantage when using cheap, unmanned vehicles, secondly because advance warning of a possible attack, provided it is cheap, at least wastes enemy time relocating artillery and at best destroys it.

Small drones have successfully countered artillery in Ukraine, and this method can neutralize artillery in potential future conflicts where artillery is expected to be decisive. The method allows simultaneous “swarm” drone attacks on multiple targets without needing individual pilots, scaling up First-Person View (FPV) drone methods.

### PRIOR ART

There are some analogies with the way UK Royal Air Force bomber command operated during the later part of World War 2.
1. Pathfinder aeroplane(s) would locate the target approximately and drop flares on it (analogous to dropping CRIMs)
2. The Master Bomber would then circle the target to identify where the flares had fallen relative to the target (analogous to a satellite or surveillance drone imaging the battlefield to define the position of the target with respect to the CRIMs).
3. Using radio communication, the Master Bomber would provide real-time instructions to the incoming bomber formations (analogous to the low-data rate updating of target location with respect to CRIMs).
4. Crucially these instructions may be more sophisticated than to simply drop bombs on the flares: If the initial markers were off-target due to wind drift or enemy countermeasures, the Master Bomber could instruct crews to adjust their aiming points relative to the markers. For example “Bomb 500 yards north of the red markers.”. This is analogous to defining the target coordinates in 3D with respect to—but not at—the locations of the CRIMs.
5. Germans would often try to trick the bombers by lighting flares to confuse them. This was countered by the RAF using particular coloured flares agreed in advance of the raid, and by the master bomber recognising where spurious flares appeared outside the pattern of flares dropped by the pathfinder. This is where CRIMs can be significantly better; there are thousands of codes available to be carried by the CRIMs, not just a few colours, so its virtually impossible to fake them to cause confusion. This makes use of modern information-theoretic concepts that simply were not available in the 1940s.

What we implement is the extension of these techniques using modern UAVs and imaging, plus an information-theoretic approach in terms of CRIMs having a large Hamming distance from each other.

The Germans frequently attempted to extinguish or obscure the marker flares dropped by the RAF's Pathfinder Force. The Germans organized specialized mobile firefighting units that would race to rapidly extinguish the burning markers. In response, the RAF developed strategies to counter these efforts, including dropping an overwhelming number of markers to make it impractical for German forces to extinguish them all. Just as we drop so many TIs as CRIMs it's not feasible to destroy or move them all before the attack drone(s) arrive.

### FIGURE CAPTIONS

FIG. 1: An aircraft (101), such as a drone or manned aircraft, carrying a plurality of Target Indicators (TIs) (102), approaches a target (110) from a high altitude. The TIs are securely held by a controlled release mechanism (105) for deployment around the target area.

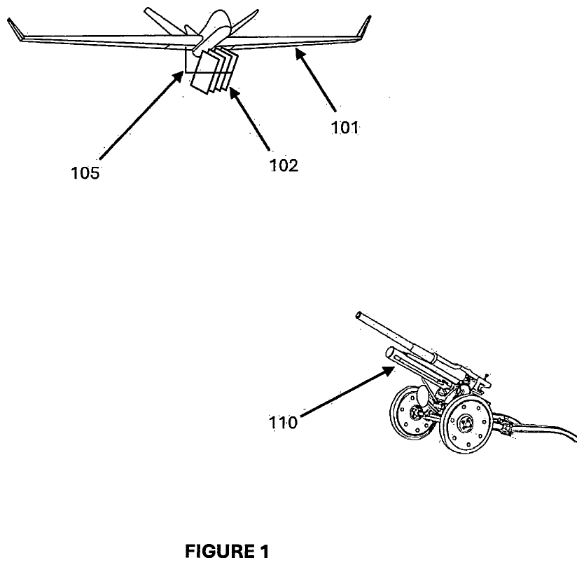

FIG. 2: Release of TIs (210) from the aircraft upon activation of the release mechanism (205), either remotely commanded or autonomously based on pre-determined location parameters, allowing TIs to scatter around the target.

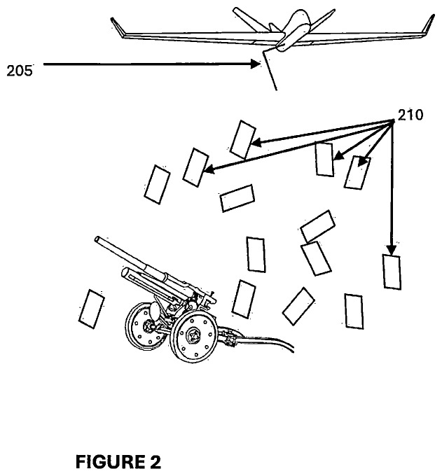

FIG. 3: The TIs (301) settle on the ground near the target, demonstrating their dispersal pattern upon release from the aircraft.

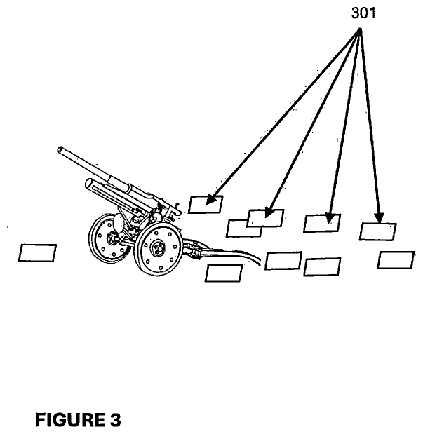

FIG. 4: Various options for capturing images of the deployed TIs around the target, including satellite (405), manned aircraft (410), or surveillance drone (415), which relay images to the command center for target localization.

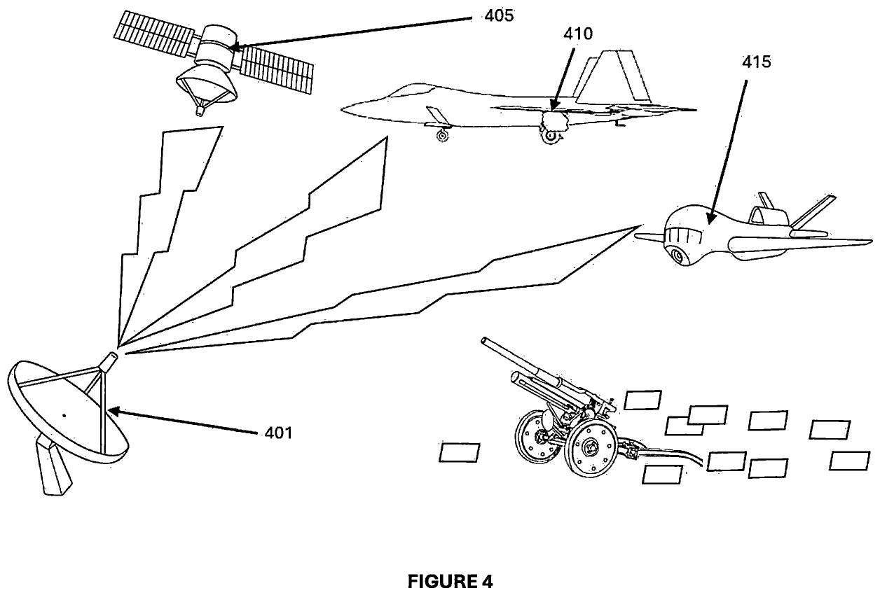

FIG. 5: An attack drone (501) utilizing a camera and onboard computer to identify TIs in the battlefield using projective geometry. The drone ignores defaced (520) and displaced (530) TIs, relying only on TIs whose relative positioning has not changed (510) for target location.

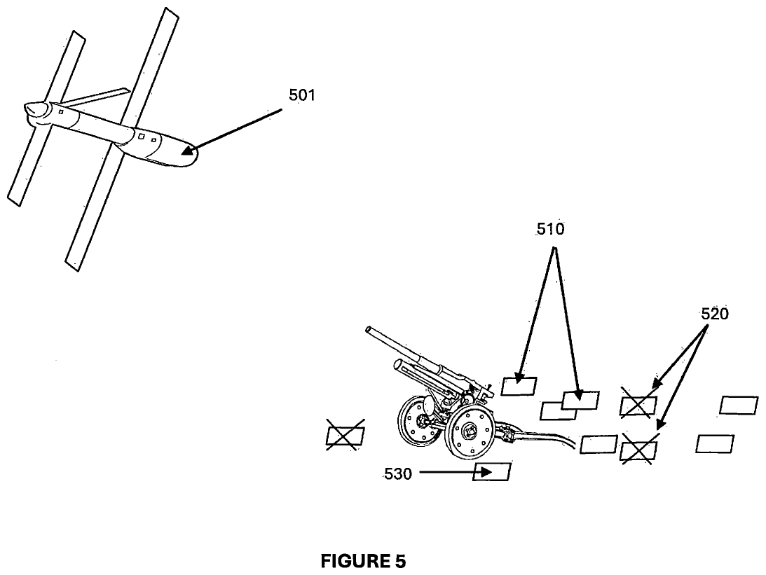

FIG. 6: The attack drone (601) navigates towards the target using identified unmoved TIs (610) (as determined to be the largest set of TIs whose relative positioning has not changed), plotting an accurate course (605) based on their positions.

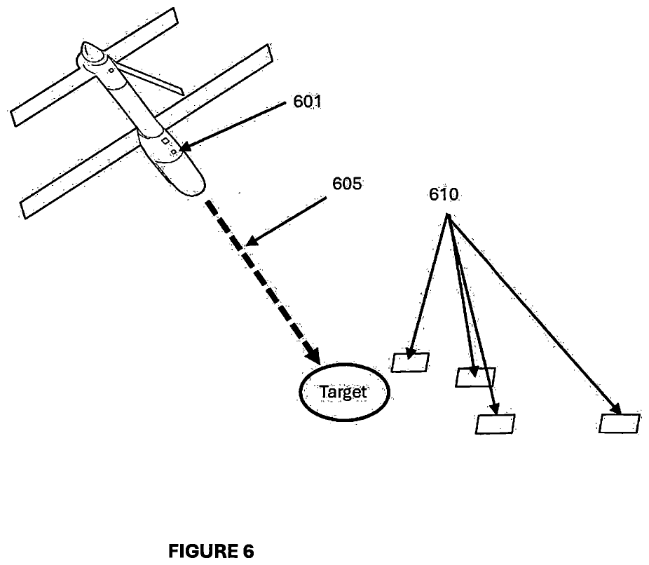

FIG. 7: The attack drone successfully impacts the target, guided accurately by the stable TIs.

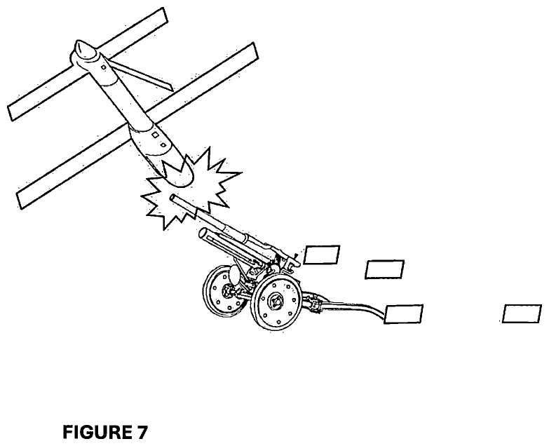

FIG. 8: Update of the attack drone's target location using low-data-rate radio signals (810 and 820) relayed through a satellite (805), which provides updated coordinates when the target position (802) shifts.

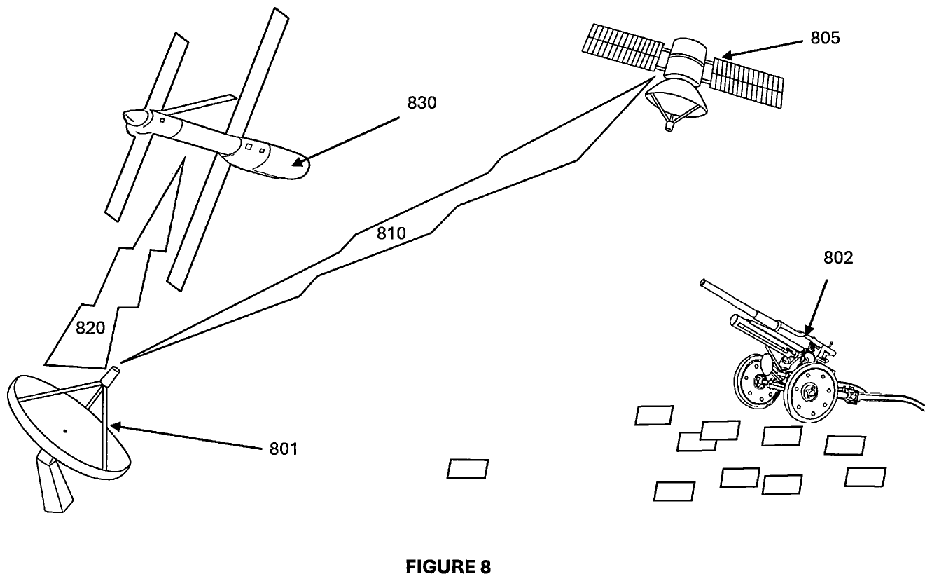

FIG. 9: Illustration of the attack drone adjusting its trajectory to accurately engage the target at its new location after receiving updated coordinates.

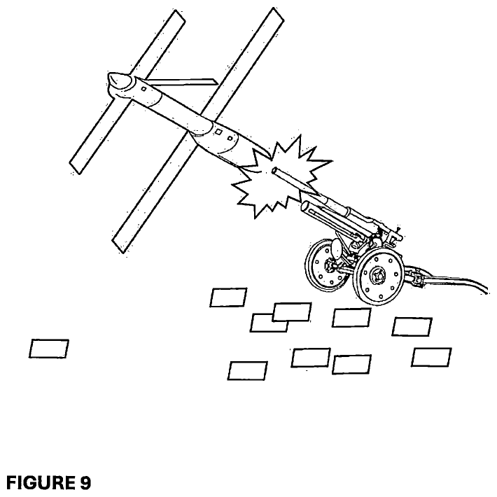

FIG. 10: Example of various fiducial markers, including QR codes and Apriltags, used as Computer-Readable Image Markers (CRIMs) for positioning and targeting purposes.

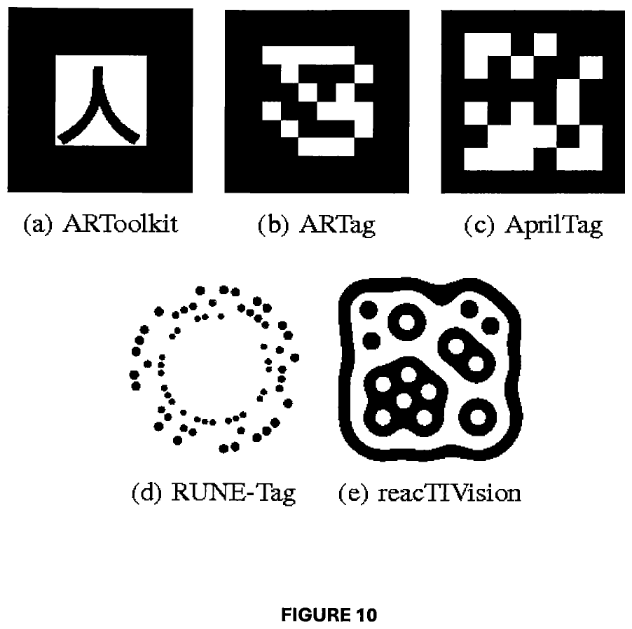

FIG. 11: As for FIG. 10, a variety of fiducial markers that may be used as Computer-Readable Image Markers (CRIMs) for positioning and targeting purposes.

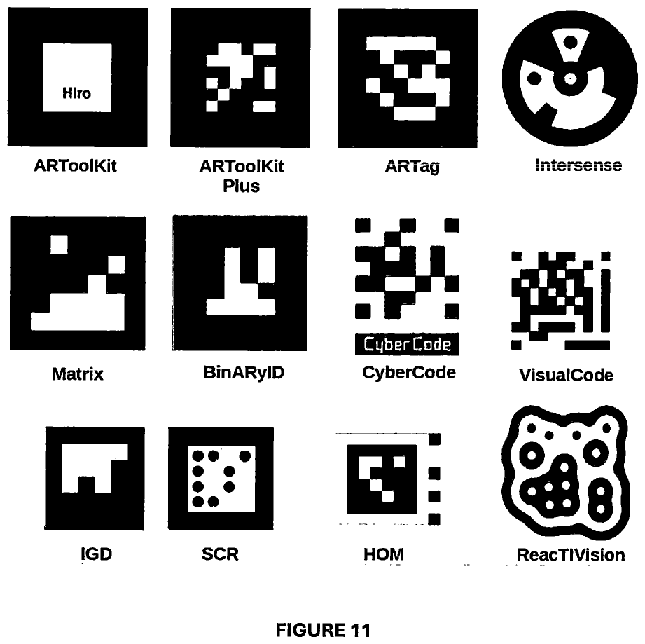

FIG. 12. Schematic of an example “CRIM”—an apriltag from family 49H12 printed on paper or plastic sheet. This may be A4, A3, A2, A1 or even A0 size, for example. The code number of this code is 49, but a large selection of different code numbers on different sheets should be used.

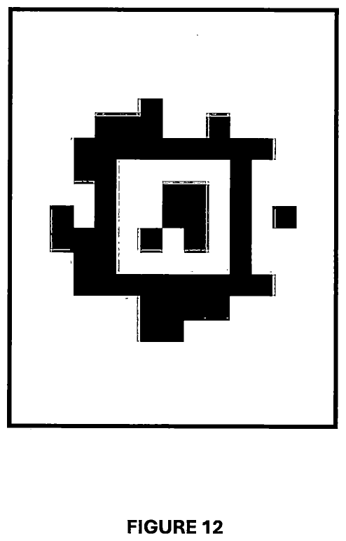

FIG. 13: Graph of the probability of a valid coordinate system according to the number of surviving (unmoved, undestroyed) CRIM TIs, according to the Bayesian model developed in the text.

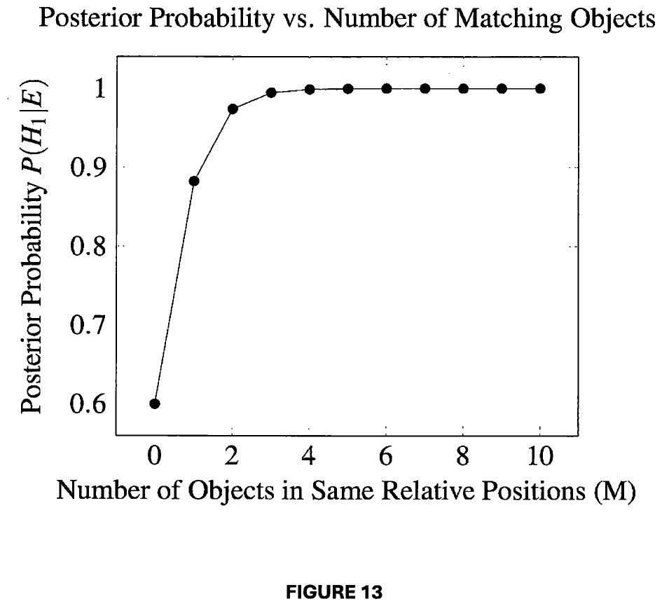

FIG. 14: Graph of the probability of a valid coordinate system according to the number of surviving (unmoved, undestroyed) CRIM TIs, according to the Bayesian model developed in the text. Here a logarithmic vertical axis is used, so that it is clear that the chances of an error in target location become vanishingly small with a modest number of undisturbed TIs. For example, even if 90% of the TIs are disturbed or destroyed, 8 undisturbed CRIM TIs are sufficient to ensure that all but one in a million target location attempts will be accurate.

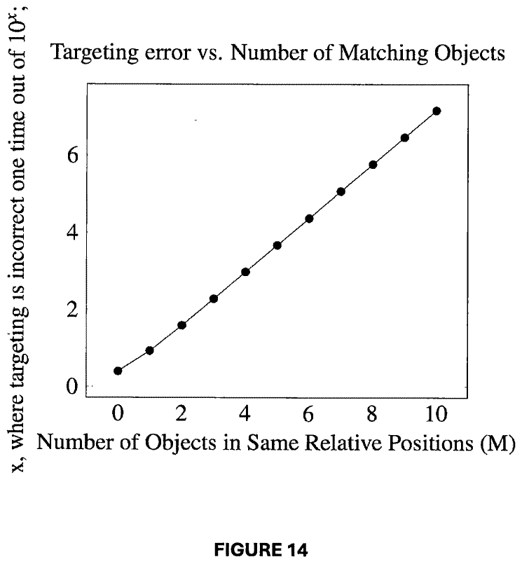

### REFERENCES

¹ Siva, J., Poellabauer, C. (2019). Robot and Drone Localization in GPS-Denied Areas. In: Ammari, H. (eds) Mission-Oriented Sensor Networks and Systems: Art and Science. Studies in Systems, Decision and Control, vol 164. Springer, Cham. https://doi.org/10.1007/978-3-319-92384-0_17
² https://www.telegraph.co.uk/world-news/2024/04/08/ukraine-developing-unstoppable-ai-powered-attack-drone/
³ Cheng C, Li X, Xie L, Li L. A Unmanned Aerial Vehicle (UAV)/Unmanned Ground Vehicle (UGV) Dynamic Autonomous Docking Scheme in GPS-Denied Environments. Drones. 2023; 7(10):613. https://doi.org/10.3390/drones7100613
⁴ Miguel Oliveira et al, A ROS framework for the extrinsic calibration of intelligent vehicles: A multi-sensor, multi-modal approach, Robotics and Autonomous Systems, Volume 131, 2020, 103558, ISSN 0921-8890
⁵ https://www.telegraph.co.uk/world-news/2024/10/16/horror-weapon-transform-warfare/
⁶ https://www.osmo-products.com/products/thirsty-sock-spill-absorption/7
⁷ Jujiang Liu, Chunxiang Yan. An integrated UWB-Vision framework for autonomous approach and landing of UAVs in GPS-Denied environments. Mathematical Foundations of Computing. doi: 10.3934/mfc.2024022
⁸ Cumpson P; Sheriff J; Fletcher IW, 2020, ‘Computer-readable Image Markers for Automated Registration in Correlative Microscopy’, arXiv preprint arXiv: 2011.14949, https://arxiv.org/abs/2011.14949
⁹ https://www.mathworks.com/help/vision/ug/camera-calibration-using-apriltag-markers.html
¹⁰ https://github.com/AprilRobotics/apriltag
¹¹ https://people.csail.mit.edu/kaess/apriltags/
¹² S. Garrido-Jurado, R. Muñoz-Salinas, F. J. Madrid-Cuevas, M. J. Marin-Jiménez, Automatic generation and detection of highly reliable fiducial markers under occlusion, Pattern Recognition, Volume 47, Issue 6, 2014,Pages 2280-2292, https://doi.org/10.1016/j.patcog.2014.01.005.
¹³ https://iris.unive.it/bitstream/10278/33533/1/2011-CVPR-netag-published.pdf, https://iecexplore.ieee.org/document/5995544
¹⁴ S. Garrido-Jurado, R. Muñoz-Salinas, F. J. Madrid-Cuevas, M. J. Marín-Jiménez, “Automatic generation and detection of highly reliable fiducial markers under occlusion”, Pattern Recognition, Volume 47, Issue 6,2014, Pages 2280-2292
¹⁵ S. Garrido-Jurado, R. Muñoz-Salinas, F. J. Madrid-Cuevas, M. J. Marín-Jiménez, Automatic generation and detection of highly reliable fiducial markers under occlusion, Pattern Recognition, Volume 47, Issue 6, 2014, Pages 2280-2292
¹⁶ https://www.rand.org/pubs/commentary/2023/11/chinese-strategists-evaluate-the-use-of-kamikaze-drones.html

1. A system for autonomous targeting of munitions using Computer-Readable Image Markers (CRIMs), comprising:
a plurality of CRIMs, each having a unique identifier and constructed from lightweight, durable materials;
a chemical anchor integrated with each CRIM, capable of absorbing environmental moisture to increase its weight and stabilize its ground position;
an aircraft configured to deploy the plurality of CRIMs around a predefined target area;
a high-altitude imaging device configured to capture images of the CRIMs and the target area;
a processing unit programmed to analyze the relative stability of each CRIM's position, and to generate a digital map marking the target and CRIMs, wherein the processing unit is configured to ignore CRIMs that exhibit relative positional changes.

2. The system of claim 1, wherein the processing unit utilizes projective geometry to determine the coordinates of the target based on the relative positions of stable CRIMs.

3. The system of claim 1, wherein information-theoretic principles are applied to validate the relative stability of CRIMs, enabling target localization despite potential movement or destruction of a subset of CRIMs.

4. A method for autonomous navigation of a drone to a target in a GPS-denied environment, comprising the steps of:
distributing a plurality of CRIMs around the target area by deploying them from an aircraft or drone;
capturing an image of the CRIMs and the target using a high-altitude imaging device;
processing the captured image to identify the locations of the CRIMs and generating a digital map for navigation;
programming the drone to utilize only CRIMs that maintain stable relative positions for autonomous navigation to the target.

5. The method of claim 4, wherein the processing unit employs a probabilistic model to assess and confirm CRIM stability based on observed relative positions.

6. The system of claim 1, wherein the chemical anchor comprises a water-absorbing material selected from a group including sodium polyacrylate, calcium chloride, and lithium chloride.

7. The system of claim 1, wherein the CRIMs are manufactured to be selectively reflective in the near-infrared spectrum, allowing detection by imaging devices equipped with corresponding filters.

8. The method of claim 4, further comprising the step of periodically updating the drone's target coordinates based on real-time CRIM positioning data from low-bandwidth communication channels.

9. The method of claim 4, wherein the CRIMs are arranged randomly around the target, ensuring that at least three CRIMs maintain stable relative positions for reliable targeting.

10. The system of claim 1, wherein the CRIMs are printed with inks that fluoresce under ultraviolet light, facilitating target identification in low-light or nighttime environments.

11. The method of claim 4, further comprising programming the drone to execute evasive maneuvers following the emission of a UV light pulse, enhancing the CRIMs' visibility without compromising the drone's position.

12. The system of claim 1, wherein the digital map is generated using a coordinate reference system selected from the group consisting of the NATO Military Grid Reference System (MGRS) and Universal Transverse Mercator (UTM).

13. The method of claim 4, wherein image processing algorithms with high specificity are used to identify CRIMs, minimizing the risk of false positives.

14. A drone for autonomous targeting and navigation, comprising:
a GPS-independent navigation unit,
an imaging device capable of capturing CRIMs,
a processing unit that evaluates CRIM data and determines CRIM reliability based on their relative positions.

15. The system of claim 1, wherein the processing unit disregards CRIMs that have been defaced, displaced, or exhibit irregularities in relative positioning.

16. The method of claim 4, wherein the CRIMs are designed with a hamming distance of five or greater, reducing the likelihood of false-positive identification.

17. The system of claim 1, wherein the CRIMs include a camouflage layer that reflects specific wavelengths invisible to the human eye, but identifiable by imaging devices equipped with compatible filters.

18. The method of claim 4, further comprising using metameric printing techniques for CRIMs, making them inconspicuous in visible light but detectable in specific spectral ranges such as near-infrared.

19. The system of claim 1, wherein each CRIM includes dual-sided coding, allowing identification regardless of landing orientation.

20. The method of claim 4, further comprising the step of verifying target coordinates in real-time by comparing CRIM positions recorded in earlier and recent images, thus compensating for any potential displacement.
